(19) United States
(12) Patent Application Publication
(10) Pub. No.: US 2015/0316444 A1
(43) Pub. Date: Nov. 5, 2015

(54) SENSOR CONTROL DEVICE, SENSOR CONTROL SYSTEM, AND SENSOR CONTROL METHOD

(71) Applicant: NGK SPARK PLUG CO., LTD., Nagoya-shi, Aichi (JP)

(72) Inventor: Toshiya MATSUOKA, Kaizu-shi, Gifu (JP)

(73) Assignee: NGK SPARK PLUG CO., LTD., Nagoya-shi, Aichi (JP)

(21) Appl. No.: 14/648,956

(22) PCT Filed: Nov. 28, 2013
(86) PCT No.: PCT/JP2013/082047

§ 371 Date: Jun. 2, 2015

(30) Foreign Application Priority Data
Dec. 4, 2012 (JP) 2012-265261

(51) Int. Cl. G01M 15/04; F02D 41/08; F02D 41/14

(52) U.S. Cl. CPC G01M 15/042; F02D 41/144; F02D 41/1454; F02D 41/08

(57) ABSTRACT

A sensor control apparatus includes a detection section and a computation section. The detection section detects an output signal output from a sensor element and changing in accordance with oxygen concentration. The computation section obtains, as correction information used for calculation of a correction coefficient, the output signal obtained in a period during which recirculation of exhaust gas into an intake atmosphere by an exhaust gas recirculation apparatus is stopped and an idle stop operation of an internal combustion engine is being performed.

### CROSS REFERENCE TO RELATED APPLICATION

This international application claims priority to Japanese Patent Application No. 2012-265261 filed with Japanese Patent Office on Dec. 4, 2012, and the entire contents of Japanese Patent Application No. 2012-265261 are incorporated herein by reference.

### TECHNICAL FIELD

The present invention relates to a sensor control apparatus (device), a sensor control system, and a sensor control method.

### BACKGROUND ART

In the case of an internal combustion engine, in general, an air-fuel ratio which is the ratio of fuel to intake air; more specifically, the ratio of fuel to oxygen contained in the intake air, is controlled in order to improve fuel efficiency and reduce harmful substances contained in exhaust gas. In order to perform such control, measurement of the volume of intake air is necessary. For example, there is known a method of measuring the volume of intake air using an air mass flow sensor. When an air mass flow sensor is used for an internal combustion engine having an intake throttle valve, the sensor can measure the volume of intake air taken into each cylinder which changes in accordance with the operation state of the engine.

Meanwhile, in the case of a diesel engine, a direct injection gasoline engine, or the like, no intake valve is provided, and the volume of intake air taken into each cylinder is basically constant. Further, in the case of a diesel engine or the like which has an exhaust gas recirculation apparatus (hereinafter referred to as an “EGR apparatus”) for partially recirculating to the intake air exhaust gas produced as a result of combustion, the ratio of oxygen contained in intake air (in other words, the amount of oxygen taken into each cylinder) changes with the amount of recirculated exhaust gas (hereinafter referred to as the “EGR amount”).

In this case, it has been difficult to accurately control the air-fuel ratio solely through use of the above-described air mass flow sensor. Namely, in the air-fuel ratio control performed using an air mass flow sensor only, the amount of oxygen taken into each cylinder is calculated under the assumption that the ratio of oxygen contained in intake air is the same as the ratio of oxygen contained in the air. In the case of an internal combustion engine having an EGR apparatus, since the ratio of oxygen contained in intake air changes, it has been impossible to accurately calculate the amount of oxygen taken into each cylinder.

In order to solve the above-described problem, there has been proposed a technique of calculating the amount of oxygen taken into each cylinder using an oxygen sensor which measures the oxygen concentration of intake air (see, for example, Patent Document 1). In this technique, the volume of intake air taken into each cylinder is measured through use of an air mass flow sensor, and the oxygen concentration of intake air is measured through use of an oxygen sensor, whereby the amount of oxygen taken into each cylinder is calculated. It has been considered favorable to control the air-fuel ratio by feedforward control in which the amount of fuel injected into the cylinder or the intake port thereof in accordance with the amount of oxygen calculated as described above.

### PRIOR ART DOCUMENT

### Patent Document

Patent Document 1: Japanese Patent Application Laid-Open (kokai) No. H2-221647

### SUMMARY OF THE INVENTION

### Problems to be Solved by the Invention

It has been known that in the case where an oxygen sensor is used as described above, it is necessary to correct for a change in output value due to, for example, deterioration of the oxygen sensor. In particular, in the case where an oxygen sensor is disposed only in the intake system of the internal combustion engine, the output of the oxygen sensor must have higher accuracy and the necessity of correction becomes higher, as compared with the case where an oxygen sensor is disposed in each of the intake system and the exhaust system.

Therefore, in the technique disclosed in Patent Document 1 as well, the output value of the oxygen sensor is corrected after stoppage of the internal combustion engine. Specifically, when an ignition key for the internal combustion engine is turned off, the output of the oxygen sensor is read, the atmospheric pressure is detected, and a sensor correction coefficient used for correction of the output of the oxygen sensor is computed.

As described above, in the technique disclosed in Patent Document 1, the operation of obtaining data (the output of the oxygen sensor and the atmospheric pressure) used for computation of the sensor correction coefficient is performed only after the ignition key is turned off, and the timing at which such data is obtained is only one time. Therefore, the technique has a problem of having difficulty maintaining the accuracy of the sensor correction coefficient.

Namely, since the sensor correction coefficient is obtained on the basis of the data obtained one time, if accurate data fails to be obtained, the sensor correction coefficient is obtained on the basis of inaccurate data, which raises a problem of difficulty in maintaining the accuracy of the sensor correction coefficient. Further, data are obtained only after the ignition key is turned off; in other words, the frequency at which data are obtained is low, and the frequency at which the sensor correction coefficient is updated is low. Therefore, the conventional technique has a problem of having difficulty eliminating the influence of filature to obtain accurate data.

In one aspect of the present invention, it is desired to provide a sensor control apparatus, a sensor control system, and a sensor control method which can suppress deterioration of the measurement accuracy of an oxygen sensor.

### Means for Solving the Problems

A sensor control apparatus according to one aspect of the present invention is connected to an oxygen sensor having a sensor element for measuring oxygen concentration of an intake atmosphere of an internal combustion engine equipped with an exhaust gas recirculation apparatus. This sensor control apparatus includes a detection section and a computation section.

The detection section detects an output signal output from the sensor element and changing in accordance with the oxygen concentration. The computation section calculates a correction coefficient for the output signal used for calculation of the oxygen concentration.

Also, the computation section obtains, as correction information used for calculation of the correction coefficient, the output signal in a period during which recirculation of exhaust gas into the intake atmosphere by the exhaust gas recirculation apparatus is stopped and the internal combustion engine is performing an idle stop operation.

A sensor control method according to another aspect of the present invention is a sensor control method for an oxygen sensor having a sensor element for measuring oxygen concentration of an intake atmosphere of an internal combustion engine equipped with an exhaust gas recirculation apparatus. This sensor control method comprises a detection step, a condition judgment step, a recirculation stopping step, an idle stop step, an obtainment step, and a calculation step.

In the detection step, an output signal output from the sensor element and changing in accordance with the oxygen concentration is detected. In the condition judgment step, a judgment is made at to whether or not a condition for an idle stop operation of the internal combustion engine is satisfied. In the recirculation stopping step, recirculation of exhaust gas into the intake atmosphere by the exhaust gas recirculation apparatus is stopped. In the idle stop step, the idle stop operation of the internal combustion engine is performed after performance of the condition judgment step and the recirculation stopping step. In the obtainment step, the output signal obtained in a period during which the idle stop operation is performed is obtained as the correction information used for calculation of the correction coefficient. In the calculation step, the correction coefficient is calculated on the basis of the obtained correction information.

In the sensor control apparatus and the sensor control method, the timing of obtainment of correction information used for calculation of the correction coefficient for correcting the output signal of the sensor element is set to a period during which the internal combustion engine is performing the idle stop operation in a state in which recirculation of the exhaust gas into intake air (intake atmosphere) is stopped. Therefore, as compared with the case of Patent Document 1, the chance of obtaining the correction information can be easily secured, and the number of times the correction information is obtained can be easily increased.

Namely, the idle stop occurs at a high frequency in the case where the internal combustion engine is operated in an ordinary operating state (e.g., when the vehicle on which the internal combustion engine is mounted travels in a city). Therefore, as compared with the case where the internal combustion engine is stopped (manually stopped) by turning the ignition key off, the chance of obtaining the correction information can be easily secured, whereby deterioration of the measurement accuracy of the oxygen sensor can be easily suppressed. Also, no limitation is imposed on the number of times the correction information is obtained during the idle stop operation. Therefore, an accurate correction coefficient can be calculated on the basis of a larger number of pieces of the correction information, whereby deterioration of the measurement accuracy of the oxygen sensor can be easily suppressed. Moreover, the output signal of the sensor element obtained during the idle stop operation is acquired as the correction information. Therefore, correction information whose dependency on the flow (flow velocity) of the intake air is reduced is obtained, whereby an accurate correction coefficient can be calculated.

Further, when the correction information is obtained, in addition to the idling operation, the recirculation of the exhaust gas to the intake air is stopped. Therefore, the influence of the exhaust gas on the output signal output from the sensor element 11 is mitigated. Notably, in the case where the idle stop operation is performed after stoppage of recirculation of the exhaust gas, it is preferred to perform the idle stop operation after elapse of a predetermined wait time from the stoppage of recirculation of the exhaust gas. In this case, the exhaust gas recirculated immediately before the stoppage of the recirculation is taken into the internal combustion engine (into the cylinders). Therefore, the intake atmosphere around the sensor element becomes equal to the air, whereby the influence of the exhaust gas on the output signal output from the sensor element can be eliminated more.

In the above-descried sensor control apparatus, the computation section may obtain the correction information when a predetermined period elapses after the internal combustion engine has started the idle stop operation.

The above-descried sensor control method may further comprise a period judgment step of judging whether or not a predetermined period has elapsed after the idle stop operation of the internal combustion engine had been started in the idle stop step, wherein the obtainment step is performed when the predetermined period is judged to have elapsed in the period judgment step.

In the case where, as described above, the correction information is obtained at a point in each period during which the internal combustion engine performs the idle stop operation, the point being after elapse of a predetermined period from the start of the idle stop operation, deterioration of the measurement accuracy of the oxygen sensor can be suppressed more easily. Namely, after the flow of intake air has stopped substantially, the correction information is obtained, and the correction coefficient is calculated. Therefore, correction information whose dependency on the flow (flow velocity) of the intake air is reduced further is obtained, whereby a more accurate correction coefficient can be calculated.

In the above-described sensor control apparatus according, the computation section may obtain the correction information a plurality of times during a single idle stop period, average a plurality of pieces of the correction information obtained during the single idle stop period so as to obtain a first average, and calculate the correction coefficient by using the first average.

In the above-described sensor control method, in the obtainment step, a plurality of pieces of the correction information may be obtained during a single idle stop period, and the plurality of pieces of the correction information obtained during the single idle stop period may be averaged so as to obtain a first average, and, in the calculation step, the correction coefficient may be calculated on the basis of the first average.

In the case where, as described above, the correction information is obtained a plurality of times during each (single) idle stop period and the correction coefficient is calculated using the first average which is the average of a plurality of pieces of the correction information, deterioration of the measurement accuracy of the oxygen sensor can be suppressed further easily. Namely, as compared with individual correction information, the above-described first average is smaller in the influence of an error contained in the the correction information when it is obtained. Therefore, by correcting the output signal of the sensor element on the basis of the correction coefficient calculated using the first average, deterioration of the measurement accuracy of the oxygen sensor can be suppressed further easily.

In the above-described sensor control apparatus, the computation section may average a plurality of the first averages so as to obtain a second average, and calculate the correction coefficient by using the second average.

In the above-described sensor control method, in the calculation step, a plurality of the first averages may be averaged so as to obtain a second average, and the correction coefficient may be calculated on the basis of the second average.

In the case where, as described above, the correction coefficient is calculated using the second average which is the average of a plurality of the first averages, deterioration of the measurement accuracy of the oxygen sensor can be suppressed further easily. Namely, as compared with the first average, the second average which is obtained by averaging a plurality of the first averages each being the average of a plurality of pieces of the correction information is smaller in the influence of an error contained in the the correction information when it is obtained. Therefore, by correcting the output signal of the sensor element on the basis of the correction coefficient calculated using the second average, deterioration of the measurement accuracy of the oxygen sensor can be suppressed further easily.

In the above-described sensor control apparatus, the computation section may obtain the average of a plurality of pieces of the correction information, and calculate the correction coefficient by using the average.

In the above-described sensor control method, in the calculation step, the correction coefficient may be calculated on the basis of the average of a plurality of pieces of the correction information.

In the case where, as described above, the correction coefficient is calculated using the average of a plurality of pieces of the correction information, deterioration of the measurement accuracy of the oxygen sensor can be suppressed further easily. Namely, by averaging a plurality of pieces of the correction information, it becomes possible to reduce the influence of the error contained in the the correction information when it is obtained, as compared with the case where the individual correction information is used. Therefore, by correcting the output signal of the sensor element on the basis of the correction coefficient calculated using the above-described average, deterioration of the measurement accuracy of the oxygen sensor can be suppressed further easily.

In the above-described sensor control apparatus, the computation section may obtain an output of an intake pressure sensor for measuring pressure of the intake atmosphere, and correct the correction information on the basis of the obtained output.

In the above-described sensor control method, in the obtainment step, the correction information may be corrected on the basis of an output of an intake pressure sensor for measuring the intake pressure of the internal combustion engine, and, in the calculation step, the correction coefficient may be calculated on the basis of the corrected correction information.

In the case where, as described above, the correction coefficient is corrected by using the output of the intake pressure sensor, deterioration of the measurement accuracy of the oxygen sensor can be suppressed further easily. Namely, the correction information may contain an error due to the influence of the pressure of the intake air (intake atmosphere). However, by correcting the correction information on the basis of the output of the intake pressure sensor, the error which is produced due to the influence of the pressure and which is contained in the correction information can be mitigated. By using the corrected correction information, deterioration of the measurement accuracy of the oxygen sensor can be suppressed further easily.

In the above-described apparatus, the computation section may obtain the output of the intake pressure sensor for measuring the pressure of the intake atmosphere and start the obtainment of the correction information after it judges that the variation amount of the output of the intake pressure sensor have become equal to or less than a specific value.

In the case where, as described above, the correction information is obtained at a point within each period during which the internal combustion engine performs the idle stop operation, the point being after the variation amount of the output of the intake pressure sensor is judged to have become equal to or less than a specific value, deterioration of the measurement accuracy of the oxygen sensor can be suppressed more easily. Namely, since the correction information is obtained and the correction coefficient is calculated after the state (flow) of intake air is judged to have become stable on the basis of the output of the intake pressure sensor, a more accurate correction coefficient can be calculated.

A sensor control system according to another aspect of the present invention includes an oxygen sensor, a state measurement section, a judgment section, and the above-described sensor control apparatus.

The oxygen sensor has a sensor element for measuring oxygen concentration of an intake atmosphere of an internal combustion engine equipped with an exhaust gas recirculation apparatus.

The state measurement section outputs a state signal corresponding to an operation state of a vehicle on which the internal combustion engine is mounted.

The judgment section judges on the basis of the state signal whether or not an idle stop condition of the internal combustion engine is satisfied, judges whether or not recirculation of exhaust gas by the exhaust gas recirculation apparatus is stopped, and judges on the basis of results of these judgments, whether or not the internal combustion engine is performing the idle stop operation.

The sensor control apparatus obtains the correction information in a period during which the judgment section judges that the idle stop operation is performed.

According to this sensor control system, the above-described sensor control apparatus is used. Therefore, deterioration of the measurement accuracy of the oxygen sensor can be suppressed more easily.

### Effects of the Invention

According to the sensor control apparatus, the sensor control system, and the sensor control method of the present invention, the output signal of the sensor element obtained in a period during which recirculation of exhaust gas is stopped and the idle stop operation of the internal combustion engine is being performed is obtained as the correction information used for calculation of the correction coefficient. The correction coefficient used for correction of the output signal of the sensor element is calculated using the correction information. Therefore, the present invention provides an advantageous effect of suppressing deterioration of the measurement accuracy of the oxygen sensor.

### BRIEF DESCRIPTION OF THE DRAWINGS

FIG. 1 Diagram showing the overall configuration of a sensor control system according to a first embodiment of the present invention.

FIG. 2 Block diagram showing the configuration of an oxygen sensor of FIG. 1.

FIG. 3 Flowchart showing processing of correcting a correction coefficient in the sensor control system of FIG. 1.

FIG. 4 Flowchart showing the processing of correcting the correction coefficient in the sensor control system of FIG. 1.

FIG. 5 Flowchart showing processing of performing an idle stop operation in an ECU.

FIG. 6 Flowchart showing the processing of correcting the correction coefficient according to a modification of the first embodiment of the present invention.

FIG. 7 Diagram showing the overall configuration of a sensor control system according to a second embodiment of the present invention.

### DESCRIPTION OF REFERENCE NUMERALS AND SYMBOLS

1, 101 . . . sensor control system, 10 . . . oxygen sensor, 11 . . . sensor element, 12, 112 . . . oxygen sensor control section (sensor control apparatus), 13 . . . detection section, 15 . . . computation section, 17 . . . heater, 40 . . . diesel engine (internal combustion engine), 43 . . . ECU (judgment section), 50 . . . EGR apparatus (exhaust gas recirculation apparatus), 61 . . . intake pressure sensor, 63 . . . vehicle speed sensor (state measurement section), 65 . . . accelerator sensor (state measurement section), 66 . . . brake sensor (state measurement section), Ip . . . output signal, Ipcomp . . . correction coefficient, Ipavz . . . average (first average), Ipavzave . . . average (second average), S21 . . . condition judgment step, S24 . . . recirculation stopping step, S25 . . . wait time judgment step, S26 . . . idle stop step, S30 . . . period judgment step, S41 . . . obtainment step, S53 . . . calculation step,

### MODES FOR CARRYING OUT THE INVENTION

### First embodiment

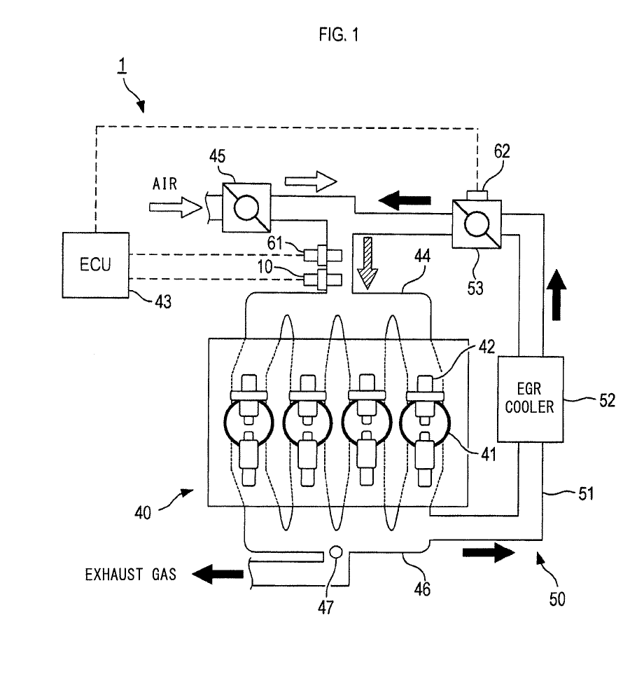

A sensor control apparatus, a sensor control system, and a sensor control method according to a first embodiment of the present invention will be described with reference to FIGS. 1 to 5. FIG. 1 is a diagram showing the overall configuration of a sensor control system 1 according to the present embodiment.

The sensor control system 1 of the present embodiment is provided for a diesel engine (hereinafter referred to as the “engine”) 40 which is an internal combustion engine equipped with an EGR (exhaust gas recirculation apparatus) 50. The sensor control system 1 performs computation processing of obtaining the oxygen concentration of the intake atmosphere on the basis of an output signal Ip from an oxygen sensor 10 which measures the oxygen concentration of the intake atmosphere used for air-fuel ratio control of the engine 40 and a correction coefficient Ipcomp stored in an engine control unit 43.

Further, in the case where the accuracy of the oxygen concentration obtained by the computation processing decreases due to, for example, deterioration of a sensor element 11 constituting the oxygen sensor 10, the sensor control system 1 corrects the correction coefficient Ipcomp to thereby suppress lowering of the accuracy of the oxygen concentration obtained by the computation processing.

The sensor control system 1 is mainly composed of the oxygen sensor 10; an intake pressure sensor 61 which measures the pressure of the intake atmosphere around the oxygen sensor 10; an EGR opening sensor 62 which detects the opening of an EGR valve 53 of the EGR apparatus 50; a vehicle speed sensor (state measurement section) 63 which detects the travel seed of a vehicle; a shift sensor (state measurement section) 64 which detects the selected position of a shift lever or a selection lever; an accelerator sensor (state measurement section) 65 which detects the operation of an accelerator; and a brake sensor (state measurement section) 66 which detects the operation of a brake.

The oxygen sensor 10 is provided in a flow passage through which an atmosphere taken into the engine 40 flows, and measures the oxygen concentration of the intake atmosphere. More specifically, the oxygen sensor 10 is provided on an intake manifold 44 through which the intake atmosphere (a mixture of the atmosphere (air) taken into the engine 40 and exhaust gas recirculated by the EGR apparatus 50) flows. Notably, a throttle valve 45 for controlling the flow rate of the air is provided in a region of the intake manifold 44 in which only the air flows; in other ward, an upstream region of the intake manifold 44.

The engine 40 includes a plurality of cylinders 41 in which a mixture of the intake atmosphere and fuel burns; injectors 42 which inject fuel into the corresponding cylinders 41; and the engine control unit 43 (hereinafter referred to as the “ECU 43”) which totally controls the operating state of the engine 40. In FIG. 1, an example of the engine 40 having four cylinders 41 is shown. The number of the cylinders 41 of the engine 40 is not limited to four.

In addition to the above-described intake manifold 44, an exhaust manifold 46 is attached to the engine 40. Exhaust gas produced as a result of combustion of the mixture in the cylinders 41 flows through the exhaust manifold 46. An exhaust oxygen sensor 47 which measures the oxygen concentration of the exhaust gas is disposed in the exhaust manifold 46.

As in the case of the oxygen sensor 10, the intake pressure sensor 61 is provided in the flow passage through which the atmosphere taken into the engine 40 flows. The intake pressure sensor 61 measures the pressure of the intake atmosphere around the oxygen sensor 10. Notably, a known pressure sensor can be used as the intake pressure sensor 61, and no limitation is imposed on the type thereof.

The EGR apparatus 50 includes an EGR flow passage 51 which allows recirculation of the exhaust gas from the exhaust manifold 46 to the intake manifold 44; an EGR cooler 52 which lowers the temperature of the exhaust gas flowing through the EGR flow passage 51; and an EGR valve 53 which controls the flow rate of the exhaust gas flowing through the EGR flow passage 51.

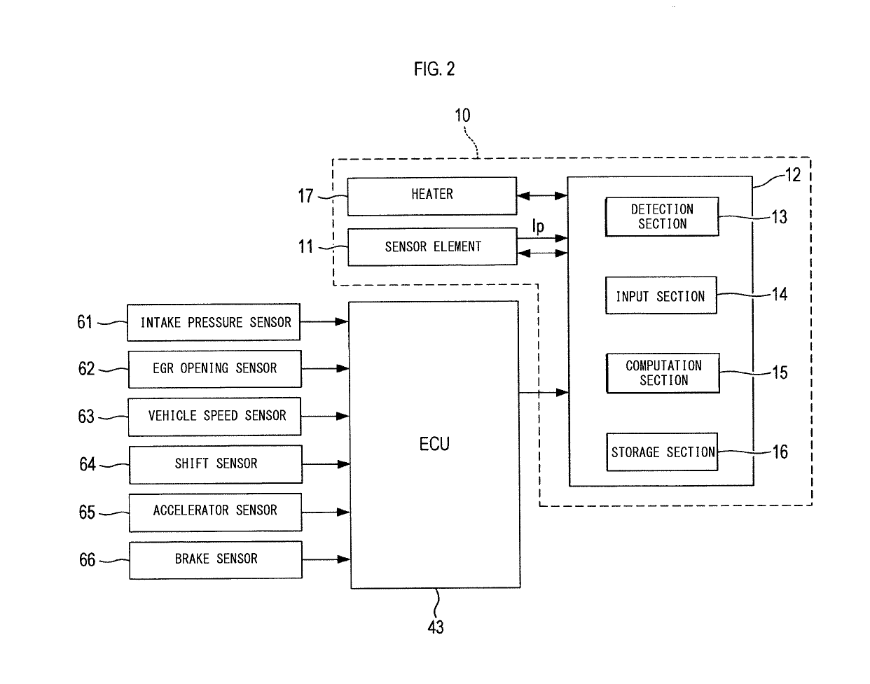

FIG. 2 is a block diagram showing the configuration of the oxygen sensor 10 of FIG. 1. As shown in FIG. 2, the oxygen sensor 10 is mainly composed of the sensor element 11 which measures the oxygen concentration of the intake atmosphere; a heater 17 which heats the sensor element 11; and an oxygen sensor control section (sensor control apparatus) 12 which corrects the output signal Ip output from the sensor element 11.

The sensor element 11 is configured such that its output signal Ip linearly changes with the oxygen concentration of the intake atmosphere. The sensor element 11 has a two-cell-type configuration in which an oxygen pump cell and an electromotive force detection cell are stacked. Each of the cells is composed of an oxygen ion conducive solid electrolyte layer mainly formed of zirconia and a pair of electrodes provided on the front and back surfaces of the layer. Since this two-cell-type sensor element 11 is known, its detailed description is omitted. However, its structure will be described briefly below.

The oxygen pump cell and the electromotive force detection cell are stacked with a spacer interposed therebetween. The spacer has a hollow measurement chamber and a porous diffusion-rate-limiting portion for introducing the intake atmosphere into the measurement chamber. One electrode of the oxygen pump cell is disposed outside the measurement chamber, and the other electrode of the oxygen pump cell is disposed inside the measurement chamber. One electrode of the electromotive force detection cell is disposed inside the measurement chamber, and the other electrode of the electromotive force detection cell is isolated from the outside atmosphere as a result of stacking of the heater 17 to be described later and is exposed to an atmosphere having a reference oxygen concentration.

The sensor element 11 is driven and controlled (energized and controlled) by the oxygen sensor control section 12. Specifically, the pump current supplied to the oxygen pump cell is controlled such that an electromotive force (voltage) produced in the electromotive force detection cell in accordance with the oxygen concentration within the measurement chamber becomes equal to a target value. At that time, the pump current flowing through the oxygen pump cell is output as an output signal Ip. This output signal Ip changes in accordance with the oxygen concentration.

The heater 17 is stacked on one side of the sensor element 11 where the electromotive force detection cell is provided, and heats the oxygen pump cell and the electromotive force detection cell for activation. The heater 17 has a known structure in which a heat generation resistor is sandwiched between two insulating layers mainly formed of alumina.

The oxygen sensor control section 12 which drives and controls (energizes and controls) the sensor element 11 and the the heater 17, etc. is connected to the oxygen sensor 10. In the present embodiment, the oxygen sensor control section 12 is connected to the oxygen sensor 10 in a form (configuration) in which the oxygen sensor control section 12 is united with the oxygen sensor 10 including the sensor element 11 and the heater 17.

When the relation between the output signal Ip output from the sensor element 11 and the oxygen concentration of the intake atmosphere changes, the oxygen sensor control section 12 updates a correction coefficient Ipcomp used for correction of the output signal Ip, to thereby correct the relation. Notably, since the energization and control of the sensor element 11 and the heater 17 by the oxygen sensor control section 12 are performed using a known circuit configuration, its detailed description is omitted.

The oxygen sensor control section 12 is mainly composed of a detection section 13 for detecting the output signal Ip output from the sensor element 11; an input section 14 for receiving control signals from the ECU (judgment section) 43; a computation section 15 for correcting the output signal Ip used for calculation of the oxygen concentration; and a storage section 16 which is a writable non-volatile memory (EEPROM).

The detection section 13 is adapted to detect the output signal Ip of the sensor element 11, and includes a filter circuit for removing noise, etc. The output signal Ip detected by the detection section 13 is input to the computation section 15.

The input section 14 receives a control signal which is output from the ECU 43 when the ECU 43 judges that the engine 40 has started an idle stop operation. Notably, the details of the operation of the ECU 43 for judging whether or not the engine 40 has started the idle stop operation will be described later.

In the present embodiment, the detection section 13 and the input section 14 are disposed separately. However, the detection section 13 and the input section 14 may be united to form an interface section, and no limitation is imposed on their configurations.

The computation section 15 is a microcomputer including a CPU (central processing unit), a ROM, a RAM, an input/output interface, etc. The computation section 15 performs computation processing of calculating and updating the correction coefficient Ipcomp for the output signal Ip of the sensor element 11 by executing a control program stored in the ROM. Notably, the computation processing performed by the computation section 15 will be described later.

The EGR opening sensor 62 detects the opening of the EGR valve 53 and outputs an opening signal to the ECU 43. The vehicle speed sensor 63 detects the travel speed of the vehicle and outputs a vehicle speed signal to the ECU 43. The shift sensor 64 detects the selected position of a sift lever or the like such as drive “D,” neutral “N,” parking “P,” etc. and outputs a selection signal to the ECU 43.

The accelerator sensor 65 detects an operation (e.g., depressing amount) of the accelerator pedal of the vehicle and outputs a detection signal to the ECU 43. The brake sensor 66 detects an operation (e.g., depressing amount) of the foot brake of the vehicle and outputs a detection signal to the ECU 43. Known sensors can be used as these sensors, and no limitation is imposed on the types of these sensors.

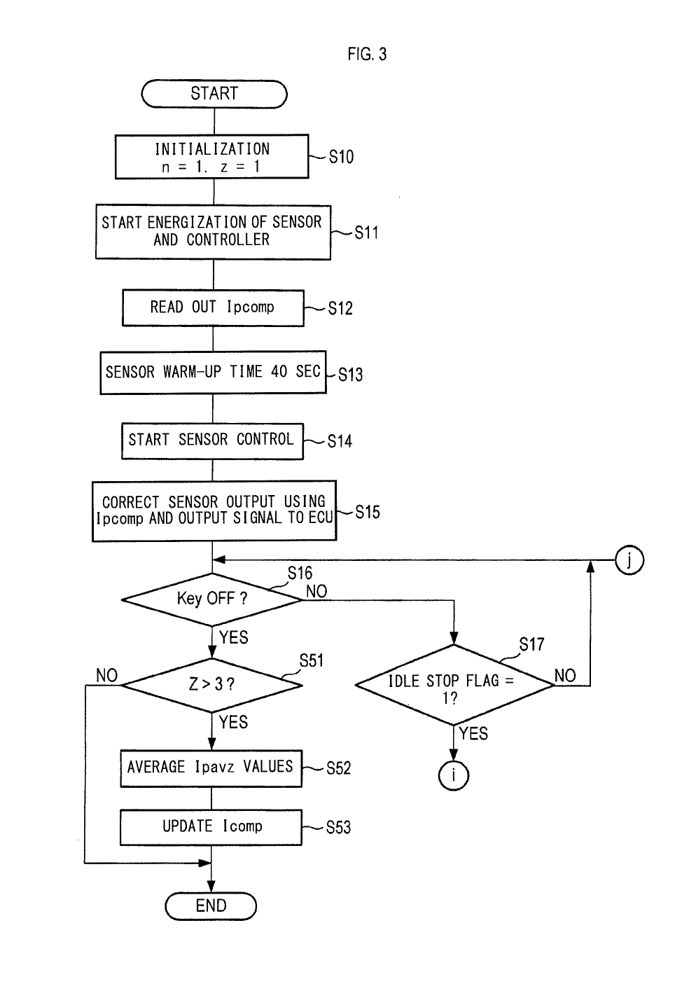

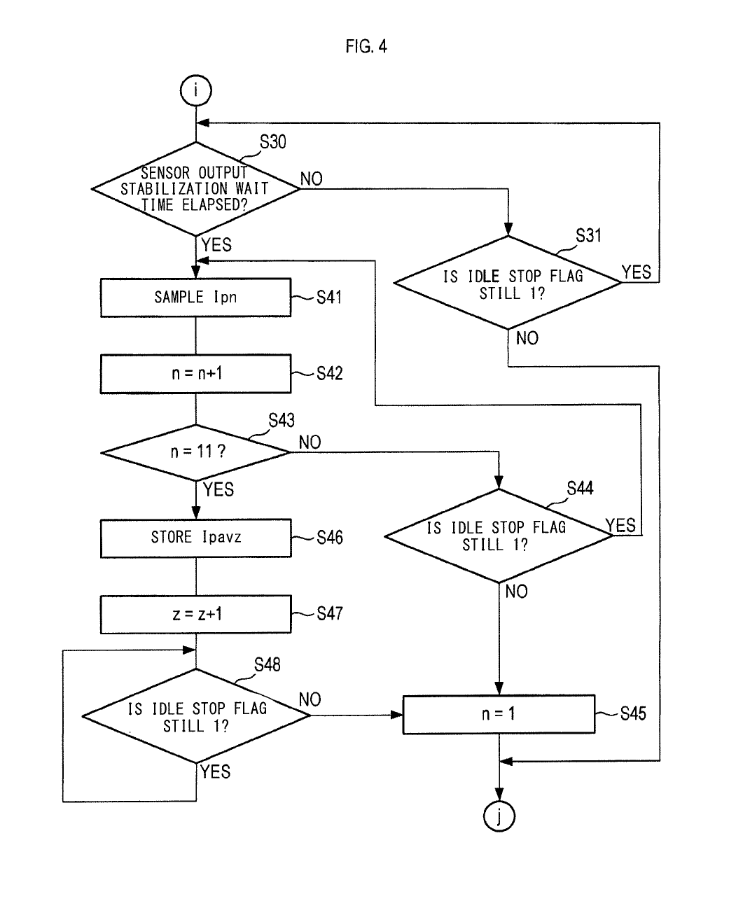

Next, with reference to FIGS. 3 and 4, there will be described the correction processing which is performed by the oxygen sensor control section 12 of the sensor control system 1 so as to update the correction coefficient Ipcomp on the basis of the output signal Ip of the sensor element 11. Notably, since the method of calculating the oxygen concentration from the output signal Ip of the sensor element 11 while using the correction coefficient Ipcomp is identical with a conventional method of multiplying the output signal Ip by the correction coefficient Ipcomp, its description is omitted.

When electric power is supplied to the sensor control system 1 and the processing of correcting the correction coefficient Ipcomp is started, as shown in the flowchart of FIG. 3 showing the processing of correcting the correction coefficient Ipcomp, the computation section 15 performs processing of resetting the value of a variable z regarding averages of the output signal Ip to “1” and performs processing of resetting a variable n regarding samples of the output signal Ip to “1” (S10).

The computation section 15 then performs control for starting the supply of electricity to the oxygen sensor 10 and the oxygen sensor control section 12 (drive/control of the heater 17, etc.) (S11). Next, the computation section 15 performs processing of reading out the latest correction coefficient Ipcomp stored in the storage section 16 (S12). Notably, in the initial state of the sensor control system 1, a correction coefficient set in advance is stored in the storage section 16 as the latest correction coefficient Ipcomp.

After that, the computation section 15 performs processing of warming up the oxygen sensor 10 for about 40 seconds to thereby activate the oxygen sensor 10 (the sensor element 11) (S13), and then starts controlling the energization of the sensor element 11 (S14). Here, the expression “warming up the oxygen sensor 10” means to generate heat from the heater 17 to thereby heat the oxygen pump cell and the electromotive force detection cell of the sensor element 11 to a temperature at which they become active. Also, the expression “controlling the energization of the sensor element 11” means to control the pump current supplied to the oxygen pump cell on the basis of the oxygen concentration within the measurement chamber such that the electromotive force (voltage) generated by the electromotive force detection cell becomes equal to the target value. The pump current flowing through the oxygen pump cell at that time is output as the output signal Ip.

The computation section 15 performs computation for correcting the output signal Ip which is the output from the sensor element 11 using the correction coefficient Ipcomp read out in S12, and performs processing of outputting the corrected signal to the ECU 43 (S15). Notably, a known computation method can be used for the computation for correcting the output signal Ip using the correction coefficient Ipcomp, and no limitation is imposed on the computation method. Notably, in the ECU 43, processing of calculating the oxygen concentration from the corrected output signal Ip is performed separately.

The computation section 15 receives from the ECU 43 a signal regarding the ignition key and performs processing of judging whether or not the ignition key is turned off (S16). In the case where the computation section 15 judges that the ignition key is not turned off (in the case of NO), the computation section 15 performs processing of judging whether or not an idle stop flag received from the ECU 43 is “1” (S17).

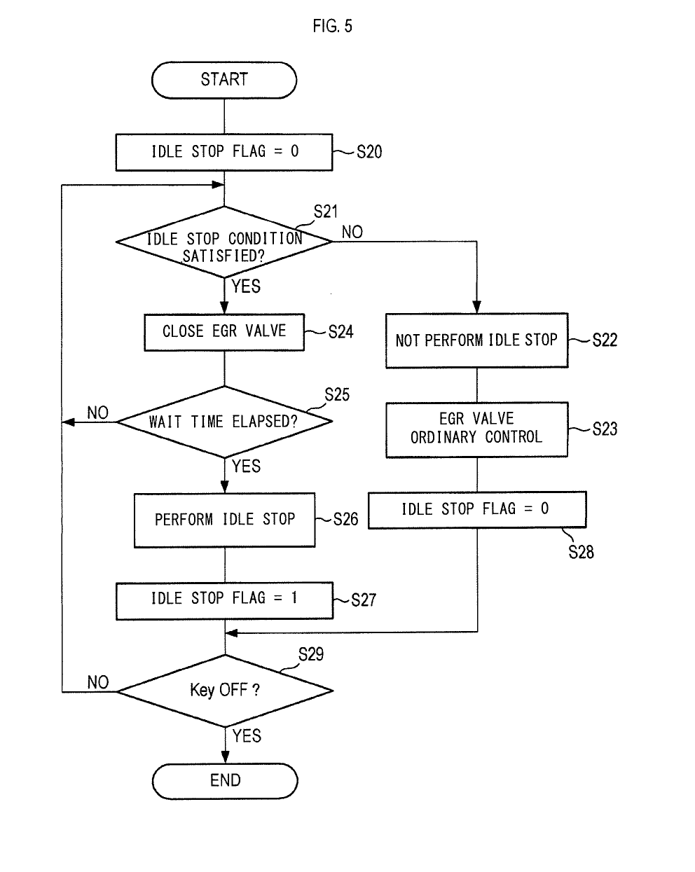

Here, idle stop execution processing which is performed by the ECU 43 so as to cause the engine 40 to perform an idle stop operation will be described with reference to the flowchart shown in FIG. 5. First, when the idle stop execution processing is started, the ECU 43 sets the idle stop flag to “0” (S20). Notably, the idle stop flag is also output to the oxygen sensor control section 12. The idle stop flag shows that the idle stop operation is being performed when the flag is “1” and shows that the idle stop operation is not performed when the flag is “0.” Next, the ECU 43 performs processing of judging whether or not an idle stop condition of the engine 40 is satisfied (condition judgment step: S21).

Specifically, the ECU 43 judges whether or not the vehicle speed signal output from the vehicle speed sensor 63 shows that the vehicle speed is 0, the selection signal output from the shift sensor 64 shows the drive “D,” the detection signal output from the accelerator sensor 65 shows that the accelerator pedal is not operated (the depression amount is 0), and the detection signal output from the brake sensor 66 shows that the foot brake is operated (is depressed). In the case where any one of these conditions is not satisfied, the ECU 43 judges that the idle stop condition is not satisfied (NO), and performs processing of not performing the idle stop operation (S22). Further, the ECU 43 outputs to the EGR apparatus 50 a control signal for performing ordinary control which is performed when the engine 40 is operated (S23). More specifically, the ECU 43 outputs to the EGR valve 53 a control signal for performing ordinary open-close control for properly recirculating the exhaust gas.

Meanwhile, in the case where all the conditions are satisfied, the ECU 43 judges in S21 that the idle stop condition is satisfied (YES), and the ECU 43 outputs to the EGR apparatus 50 a control signal for closing the EGR valve 53 (recirculation stopping step: S24). Further, the ECU 43 judges whether or not a predetermined atmosphere stabilization wait time (predetermined wait time) has elapsed after a signal indicating closure of the EGR valve 53 had been input from the EGR opening sensor 62 (wait time judgment step: S25). An example of the predetermined atmosphere wait time is about 5 seconds to about 10 seconds.

When the predetermined atmosphere stabilization wait time has elapsed after the recirculation of the exhaust gas had been stopped by closing the EGR valve 53, the exhaust gas recirculated by the EGR apparatus 50 is taken into the engine 40 (into the cylinders), and the atmosphere within the intake manifold 44 becomes approximately the same as the air.

In the case where the ECU 43 determines in S25 that the predetermined atmosphere stabilization wait time has not elapsed (the case of NO), the ECU 43 returns to S21 and repeatedly executes the above-described processing. Meanwhile, in the case where the ECU 43 determines that the predetermined atmosphere stabilization wait time has elapsed (the case of YES), the ECU 43 outputs to the engine 40 a control signal for performing the idle stop operation (idle stop step: S26).

The ECU 43 then sets the idle stop flag to “1” (S27). Meanwhile, in the case where the ECU 43 determines in S21 that the idle stop condition is not satisfied (NO), the ECU 43 outputs to the engine 40 a control signal for non-execution of the idle stop operation (S22), to thereby continue the operation of the engine 40 or restart the engine 40. Subsequently, the ECU 43 performs the above-described processing of S23 and sets the idle stop flag to “0” (S28).

After the processing of S27 or S28 for setting the idle stop flag, the ECU 43 judges whether or not the ignition key is turned off (S29). In the case where the ECU 43 judges in S29 that the ignition key is in the on state (the case of NO), the ECU 43 returns to S21 and repeats the processing of S21 and subsequent steps. Meanwhile, in the case where the ECU 43 judges in S29 that the ignition key is in the off state (the case of YES), the ECU 43 ends the idle strop execution processing.

Referring back to the description of the correction processing of updating the correction coefficient Ipcomp on the basis of the output signal Ip of the sensor element 11 shown in FIGS. 3 and 4, in the case where the computation section 15 judges in S17 that the idle stop flag is “1” (namely, the idle stop operation was performed by the idle stop execution processing shown in FIG. 5) (the case of YES), the computation section 15 judges whether or not a predetermined sensor output stabilization wait time (predetermined period) has elapsed after the idle stop flag was first judged to be 1 (period judgment step: S30).

An example of the predetermined sensor output stabilization wait time is about 10 seconds. In the case where the computation section 15 judges that the predetermined sensor output stabilization wait time has not elapsed (the case of NO), the computation section 15 judges whether or not the value of the idle stop flag input from the ECU 43 is still 1 (S31). In the case where the computation section 15 judges in S31 that the value of the idle stop flag is still 1 (the case of YES), the computation section 15 returns to S30 and performs the above-described processing.

Meanwhile, in the case where the computation section 15 judges in S31 that the value of the idle stop flag input from the ECU 43 is 0 (namely, the idle stop operation has been cancelled) (the case of NO), the computation section 15 returns to S16 of FIG. 3 and repeatedly performs the above-described processing.

In the case where the computation section 15 judges in S30 that the sensor output stabilization wait time has elapsed (the case of YES), the computation section 15 performs processing of obtaining an Ipn sample (correction information) which is the output signal Ip used for calculation of the correction coefficient (obtainment step: S41). The output signal Ip obtained as the Ipn sample is the output signal Ip output from the sensor element 11 and is a so-called raw signal. For the obtained output signal Ip, there is performed computation for removing an error due to the pressure of the atmosphere around the oxygen sensor 10, on the basis of the output of the intake pressure sensor 61 input via the ECU 43. The output signal Ip having undergone the computation is stored in the storage section 16 as the Ipn sample.

After that, the computation section 15 performs processing of updating the variable n regarding the output signal Ip sample (S42). Specifically, the computation section 15 performs processing of increasing the value of the variable n by 1. After updating the value of the variable n, the computation section 15 judges whether or not the value of the variable n is equal to 11 (S43). In other words, the computation section 15 judges whether or not the number of times of obtainment of the output signal Ip sample reaches 10 times. In the case where the value of the variable n has not yet reached 11 (the case of NO), the computation section 15 proceeds to S44 and judges whether or not the value of the idle stop flag is still 1.

In the case where the computation section 15 judges in S44 that the value of the idle stop flag is still 1 (the case of YES), the computation section 15 returns to the above-described S41 and repeatedly performs the above-described processing. Meanwhile, in the case where the computation section 15 judges in S44 that the value of the idle stop flag is 0 (namely, the idle stop operation has been cancelled), the computation section 15 proceeds to S45 so as to reset the value of the variable n to 1, and then returns to S16 of FIG. 3 so as to repeatedly perform the above-described processing.

In the case where the computation section 15 judges in S43 that the value of the variable n is equal to 11 (the case of YES), the computation section 15 performs processing of storing an average (first average) Ipavz in the storage section 16 (S46). Specifically, the computation section 15 obtains the average Ipavz by averaging the latest 10 values of Ipn stored in the storage section 16 (arithmetic mean processing), and stores the calculated average Ipavz in the storage section 16. After that, the computation section 15 performs processing of increasing the value of the variable z regarding the output signal Ip averages by one (S47).

After having updated the value of the variable z, the computation section 15 judges whether or not the value of the idle stop flag is still 1 (S48). In the case where the computation section 15 judges that the value of the idle stop flag is still 1 (the case of YES), the computation section 15 repeatedly performs the judgment of S48. Meanwhile, in the case where the computation section 15 judges that the value of the idle stop flag is 0 (namely, the idle stop operation has been cancelled) (the case of NO), the computation section 15 proceeds to S45 so as to reset the value of the variable n to 1, and then returns to S16 of FIG. 3 so as to repeatedly perform the above-described processing.

In the case where the computation section 15 judges in S16 that the ignition key is turned off (the case of YES), the computation section 15 judges whether or not the value of the variable z is greater than 3 (S51). In other words, the computation section 15 judges whether or not the number of times of calculation (obtainment) of the average Ipavz stored in the storage section 16 exceeds three times. In the case where the value of the variable z is equal to or less than 3 (the case of NO), the computation section 15 ends the present correction processing without updating the correction coefficient Ipcomp.

Meanwhile, in the case where the value of the variable z is greater than 3 (the case of YES), the computation section 15 performs computation processing of reading the latest three averages Ipavz from the storage section 16 and obtaining an average (second average) Ipavzave by averaging the averages Ipavz (arithmetic mean processing) (S52).

After having calculated the average Ipavzave, the computation section 15 performs processing of updating the value of the correction coefficient Ipcomp used up to that time (calculation step: S53). Specifically, the computation section 15 performs computation processing of calculating a new correction coefficient Ipcomp by dividing a reference value previously stored in the computation section 15 by the average Ipavzave. The computation section 15 performs processing of storing (for update) the new correction coefficient Ipcomp obtained by the computation processing in the storage section 16 as the correction coefficient Ipcomp to be used after that time. Thus, the processing of correcting the correction coefficient Ipcomp in the oxygen sensor control section 12 is completed.

According to the sensor control system 1 and the oxygen sensor control section 12 having the above-described configurations, the timing of obtainment of the output signal Ip or the like which is correction information used for calculation of the correction coefficient Ipcomp for correcting the output signal Ip of the sensor element 11 is set to a period during which the engine 40 is performing the idling stop operation in a state in which recirculation of the exhaust gas to the intake air (intake atmosphere) is stopped. Therefore, as compared with the case of Patent Document 1, the chance of obtaining the output signal Ip or the like which is the correction information can be easily secured, and the number of times the output signal Ip or the like is obtained can be easily increased. As a result, deterioration of the measurement accuracy of the oxygen sensor 10 can be easily suppressed.

Namely, in the case where the internal combustion engine is operated in an ordinary operating state, the idle stop operation may occur at a high frequency. Therefore, as compared with the case where the engine 40 is stopped (manually stopped) by turning the ignition key off, the chance of obtaining the output signal Ip or the like which is the correction information can be easily secured, whereby deterioration of the measurement accuracy of the oxygen sensor 10 can be easily suppressed. Also, no limitation is imposed on the number of times the output signal Ip or the like (correction information) is obtained during the idle stop operation. Therefore, an accurate correction coefficient Ipcomp can be calculated on the basis of a larger number of values of the output signal Ip or the like (correction information), whereby deterioration of the measurement accuracy of the oxygen sensor 10 can be easily suppressed. Moreover, the output signal of the sensor element obtained during the idle stop operation is acquired as the output signal Ip or the like which is correction information. Therefore, correction information whose dependency on the flow (flow velocity) of the intake air is reduced is obtained, whereby an accurate correction coefficient can be calculated.

Further, when the correction information is obtained, in addition to the idling operation, the recirculation of the exhaust gas to the intake air is stopped. Therefore, the influence of the exhaust gas on the output signal Ip output from the sensor element 11 is mitigated. Notably, in the case where the idling operation is sopped after stoppage of recirculation of the exhaust gas, it is preferred to perform the idle stop operation after elapse of a predetermined wait time from the stoppage of recirculation of the exhaust gas. In this case, the exhaust gas recirculated immediately before the stoppage of the recirculation is taken into the engine 40 (into the cylinders 41). Therefore, the intake atmosphere around the sensor element 11 becomes equal to the air, whereby the influence of the exhaust gas on the output signal Ip output from the sensor element 11 can be eliminated more.

The output signal Ip or the like which is correction information is obtained at a point in each period during which the engine 40 performs the idle stop operation, the point being after elapse of a predetermined sensor output stabilization period from the start of the idle stop operation. Thus, deterioration of the measurement accuracy of the oxygen sensor 10 can be suppressed more easily. Namely, after the flow of intake air has stopped substantially, the output signal Ip or the like which is correction information is obtained, and the correction coefficient Ipcomp is calculated. Therefore, correction information whose dependency on the flow (flow velocity) of the intake air is further reduced is obtained, whereby a more accurate correction coefficient can be calculated.

The output signal Ip or the like which is correction information is obtained a plurality of times during each (single) idle stop period, and the correction coefficient Ipcomp is calculated using the average Ipavz which is the average of the plurality of values of the output signal Ip or the like which is correction information. Therefore, deterioration of the measurement accuracy of the oxygen sensor 10 can be suppressed further easily. Namely, as compared with the output signal Ip which is individual correction information, the above-described average Ipavz obtained through averaging processing is smaller in the influence of an error contained in the output signal Ip or the like (correction information) when it is obtained. Therefore, by correcting the output signal Ip of the sensor element 11 on the basis of the correction coefficient Ipcomp calculated using the average Ipavz, deterioration of the measurement accuracy of the oxygen sensor 10 can be suppressed further easily.

By calculating the correction coefficient Ipcomp using the average Ipavzave which is the average of a plurality of averages Ipavz, deterioration of the measurement accuracy of the oxygen sensor 10 can be suppressed further easily. Namely, as compared with the average Ipavz, the average Ipavzave which is obtained by averaging a plurality of averages Ipavz each being the average of a plurality of values of the output signal Ip or the like which is correction information is smaller in the influence of an error contained in the output signal Ip or the like (correction information) when it is obtained. Therefore, by correcting the output signal Ip of the sensor element 11 on the basis of the correction coefficient Ipcomp calculated using the average Ipavzave, deterioration of the measurement accuracy of the oxygen sensor 10 can be suppressed further easily.

As described above, by correcting the output signal Ip which is correction information on the basis of the output of the intake pressure sensor 61, deterioration of the measurement accuracy of the oxygen sensor 10 can be suppressed further easily. Namely, the output signal Ip which is correction information may contain an error due to the influence of the pressure of the intake atmosphere. However, by correcting the output signal Ip which is correction information on the basis of the output of the intake pressure sensor 61, the error which is produced due to the influence of the pressure and which is contained in the output signal Ip (correction information) can be mitigated. By using the corrected output signal Ip, deterioration of the measurement accuracy of the oxygen sensor 10 can be suppressed further easily.

Notably, the correction coefficient Ipcomp may be corrected by using the average Ipavzave obtained through double (two stage) averaging processing as in the above-described embodiment or may be corrected by using an average obtained through single-time averaging processing. Specifically, in the former method, a plurality of values of the output signal Ip obtained during a single idle stop period are averaged to obtain an average Ipavz, a plurality of averages Ipavz are averaged to obtain an average Ipavzave, and the correction coefficient Ipcomp is corrected using the average Ipavzave. In the latter simpler method, a plurality of (for example, 100) values of the output signal Ip are obtained during a single idle stop period or a plurality of idle stop periods and are averaged to obtain an average, and the correction coefficient Ipcomp is corrected using the obtained average.

### Modification of the First Embodiment

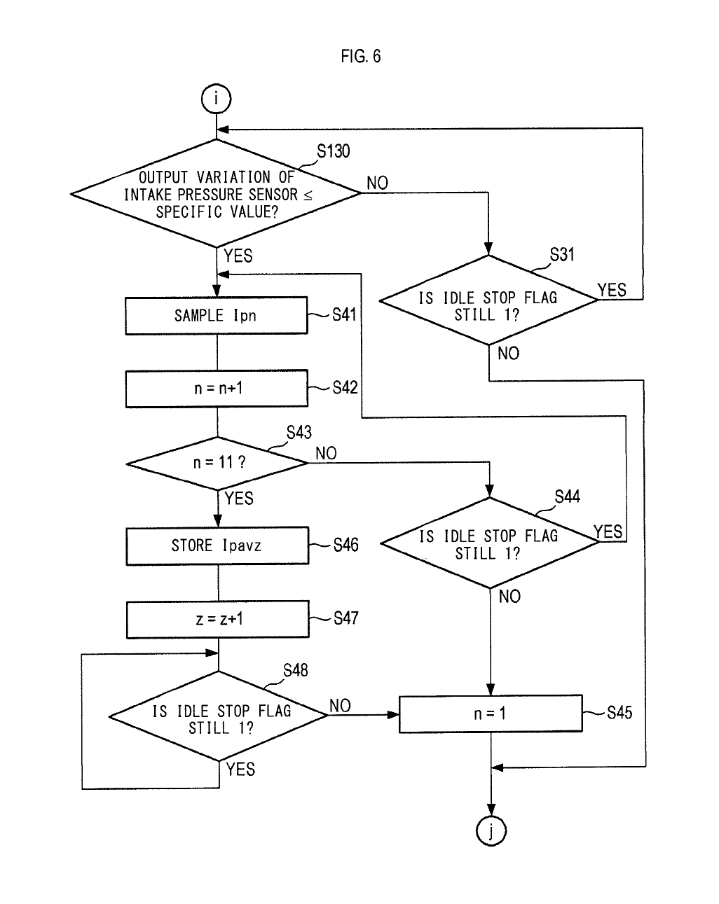

Next, a sensor control system according to a modification of the first embodiment of the present invention will be described with reference to FIG. 6. Although the basic configuration of the sensor control system of the present modification is identical to that of the sensor control system of the first embodiment, the sensor control system of the present modification differs from the sensor control system of the first embodiment in the timing at which the Ipn sample obtaining processing is performed. In the present embodiment, only the timing at which the Ipn sample obtaining processing is performed in the correction processing will be described with reference to FIG. 6, and description of the remaining portion is omitted.

Since the sensor control system 1 of the present modification has the same configuration as the sensor control system 1 of the first embodiment, its description is omitted. Further, as to the correction processing of updating the correction coefficient Ipcomp on the basis of the output signal Ip of the sensor element 11, S10 through S17 (see FIG. 3) and S41 through S53 (see FIGS. 3 and 4) of the present modification are identical with those of the first embodiment. Therefore, description of these steps is omitted. Also, since the idle stop execution processing (FIG. 5) which is performed by the ECU 43 in order to cause the engine 40 to perform the idle stop operation is the same as that in the first embodiment, its description is omitted.

Here, the correction processing of updating the correction coefficient Ipcomp on the basis of the output signal Ip of the sensor element 11, which is the feature of the present modification, will be described with reference to FIG. 6.

In the case where the computation section 15 judges in S17 that the idle stop flag is “1” (the case of YES), the computation section 15 judges whether or not the variation amount of the output of the intake pressure sensor 61 has become equal to or less than a specific value after the idle stop flag was first judged to be 1 (S130).

In the case where the computation section 15 judges in S130 that the variation amount of the output of the intake pressure sensor 61 has not yet become equal to or less than the specific value (the case of NO), the computation section judges whether or not the value of the idle stop flag input from the ECU 43 is still 1 (S31). In the case where the computation section 15 judges in S31 that the idle stop flag is still 1 (the case of YES), the computation section 15 returns to S130 and performs the above-described processing.

In the case where the computation section 15 judges in S130 that the variation amount of the output of the intake pressure sensor 61 has become equal to or less than the specific value (the case of YES), the computation section 15 performs processing of obtaining the Ipn sample (correction information) which is the output signal Ip used for calculation of the correction coefficient (obtainment step: S41). Since the processing of subsequent steps is the same as that in the first embodiment, its description is omitted.

According to the sensor control system 1 having the above-described configuration, within each period during which the engine 40 performs the idle stop operation, the output signal Ip is obtained after the variation amount of the output of the intake pressure sensor 61 is judged to have become equal to or less than the specific value. Therefore, deterioration of the measurement accuracy of the oxygen sensor 10 can be suppressed more easily. Namely, since the output signal Ip is obtained and the correction coefficient Ipcomp is calculated after the state (flow) of intake air is judged to have become stable on the basis of the output of the intake pressure sensor 61, a more accurate correction coefficient Ipcomp can be calculated.

Notably, the output signal Ip may be obtained after the variation amount of the output of the intake pressure sensor 61 is judged to have become equal to or less than the specific value as in the above-described modification, or may be obtained after waiting elapse of a predetermined sensor output stabilization wait time from the start of the idle stop operation and then judging that the variation amount of the output of the intake pressure sensor 61 has become equal to or less than the specific value. No particular limitation is imposed on the timing at which the output signal Ip is obtained.

### Second embodiment

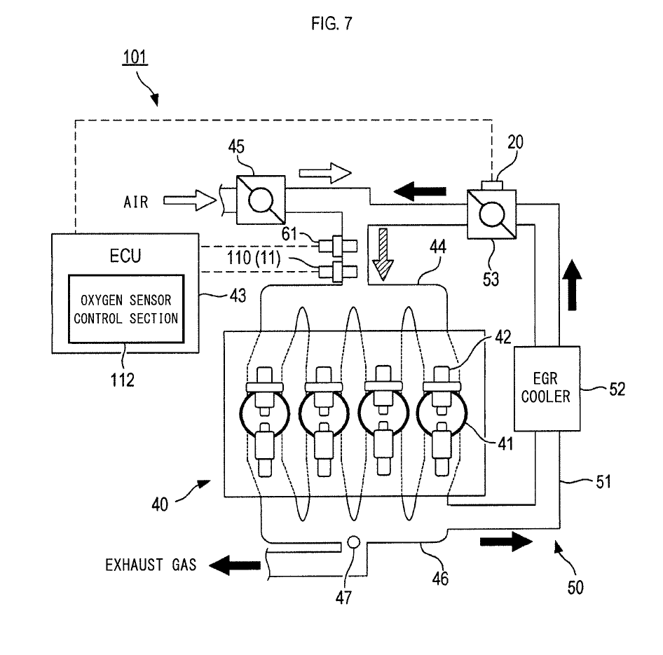

Next, a sensor control system according to a second embodiment of the present invention will be described with reference to FIG. 7. Although the basic configuration of the sensor control system of the present embodiment is the same as that of the sensor control system of the first embodiment, the sensor control system of the present embodiment differs from the sensor control system of the first embodiment in the position where the oxygen sensor control section is disposed. Therefore, in the present embodiment, only the arrangement of the oxygen sensor control section will be described using FIG. 7, and description of the remaining portion is omitted.

As shown in FIG. 7, the sensor control system 101 is mainly composed of an oxygen sensor 110 which includes a sensor element 11 for measuring the oxygen concentration of the intake atmosphere and a heater 17; an intake pressure sensor 61 which measures the pressure of the intake atmosphere around the oxygen sensor 10; an EGR opening sensor 62 which detects the opening of an EGR valve 53 of an EGR apparatus 50; a vehicle speed sensor 63 which detects the travel seed of a vehicle; a shift sensor 64 which detects the selected position of a shift lever or a selection lever; an accelerator sensor 65 which detects the operation of an accelerator; a brake sensor 66 which detects the operation of a brake; and an oxygen sensor control section (sensor control apparatus) 112 for correcting the output signal Ip output from the sensor element 11.

Namely, in the first embodiment, the oxygen sensor control section 12 is connected to the oxygen sensor 10 by uniting the oxygen sensor control section 12 with the oxygen sensor 10. The present embodiment differs from the first embodiment in the point that the oxygen sensor control section 112 is not united with the oxygen sensor 110. In the present embodiment, the oxygen sensor control section 112 is disposed in the ECU 43 which controls the engine 40.

Like the oxygen sensor control section 12 of the first embodiment, the oxygen sensor control section 112 collects the Ipn sample (correction information) when the engine 40 is operated. Also, the oxygen sensor control section 112 corrects the correction coefficient Ipcomp, to thereby allow accurate calculation of the oxygen concentration. In addition to circuits for driving and controlling (energizing and controlling the sensor element 11 and the heater 17, the oxygen sensor control section 112 mainly includes a detection section 13 for detecting the output signal Ip, an input section 14, a computation section 15 which performs correction processing for the output signal Ip, and a storage section 16 (see FIG. 2).

Since the processing of correcting the correction coefficient Ipcomp in the sensor control system 101 having the above-described configuration is the same as the correction processing in the sensor control system 1 of the first embodiment, its description is omitted.

Notably, the oxygen sensor control section 12 may be provided in a manner different from those in the first and second embodiments. Namely, the oxygen sensor control section 12 may be provided separately from the oxygen sensor 10 and the ECU 43 as an interface connected to the oxygen sensor 10 and the ECU 43.

1. A sensor control apparatus which is to be connected to an oxygen sensor having a sensor element for measuring oxygen concentration of an intake atmosphere of an internal combustion engine equipped with an exhaust gas recirculation apparatus, the sensor control apparatus comprising:
a detection section for detecting an output signal output from the sensor element and changing in accordance with the oxygen concentration; and
a computation section for calculating a correction coefficient for the output signal used for calculation of the oxygen concentration,
wherein the computation section obtains, as correction information used for calculation of the correction coefficient, the output signal in a period during which recirculation of exhaust gas into the intake atmosphere by the exhaust gas recirculation apparatus is stopped and the internal combustion engine is performing an idle stop operation.

2. A sensor control apparatus according to claim 1, wherein the computation section obtains the correction information when a predetermined period elapses after the internal combustion engine has started the idle stop operation.

3. A sensor control apparatus according to claim 1, wherein the computation section obtains the correction information a plurality of times during a single idle stop period, averages a plurality of pieces of the correction information obtained during the single idle stop period so as to obtain a first average, and calculates the correction coefficient by using the first average.

4. A sensor control apparatus according to claim 3, wherein the computation section averages a plurality of the first averages so as to obtain a second average, and calculates the correction coefficient by using the second average.

5. A sensor control apparatus according to claim 1, wherein the computation section obtains an average of a plurality of pieces of the correction information, and calculates the correction coefficient by using the average.

6. A sensor control apparatus according to claim 1, wherein the computation section obtains an output of an intake pressure sensor for measuring pressure of the intake atmosphere, and corrects the correction information on the basis of the obtained output.

7. A sensor control system comprising:
an oxygen sensor having a sensor element for measuring oxygen concentration of an intake atmosphere of an internal combustion engine equipped with an exhaust gas recirculation apparatus;
a state measurement section for outputting a state signal corresponding to an operation state of a vehicle on which the internal combustion engine is mounted;
a judgment section which judges on the basis of the state signal whether or not an idle stop condition of the internal combustion engine is satisfied, judges whether or not recirculation of exhaust gas by the exhaust gas recirculation apparatus is stopped, and judges on the basis of results of these judgments whether or not the internal combustion engine is performing the idle stop operation; and
a sensor control apparatus according to claim 1,
wherein the sensor control apparatus obtains the correction information in a period during which the judgment section judges that the idle stop operation is being performed.

8. A sensor control method for an oxygen sensor having a sensor element for measuring oxygen concentration of an intake atmosphere of an internal combustion engine equipped with an exhaust gas recirculation apparatus, the method comprising:
a detection step of detecting an output signal output from the sensor element and changing in accordance with the oxygen concentration;
a condition judgment step of judging whether or not a condition for an idle stop operation of the internal combustion engine is satisfied;
a recirculation stopping step of stopping recirculation of exhaust gas into the intake atmosphere by the exhaust gas recirculation apparatus;
an idle stop step of performing the idle stop operation of the internal combustion engine after performance of the condition judgment step and the recirculation stopping step;
an obtainment step of obtaining, as the correction information used for calculation of the correction coefficient, the output signal obtained in a period during which the idle stop operation is performed; and
a calculation step of calculating the correction coefficient on the basis of the obtained correction information.

9. A sensor control method according to claim 8, further comprising a period judgment step of judging whether or not a predetermined period has elapsed after the idle stop operation of the internal combustion engine had been started in the idle stop step, wherein the obtainment step is performed when the predetermined period is judged to have elapsed in the period judgment step.

10. A sensor control method according to claim 8 or 9, wherein
in the obtainment step, a plurality of pieces of the correction information are obtained during a single idle stop period, and the plurality of pieces of the correction information obtained during the single idle stop period are averaged so as to obtain a first average, and
in the calculation step, the correction coefficient is calculated on the basis of the first average.

11. A sensor control method according to claim 10, wherein in the calculation step, a plurality of the first averages are averaged so as to obtain a second average, and the correction coefficient is calculated on the basis of the second average.

12. A sensor control method according to claim 8, wherein in the calculation step, the correction coefficient is calculated on the basis of an average of a plurality of pieces of the correction information.

13. A sensor control method according to claim 8, wherein
in the obtainment step, the correction information is corrected on the basis of an output of an intake pressure sensor for measuring the intake pressure of the internal combustion engine, and
in the calculation step, the correction coefficient is calculated on the basis of the corrected correction information.
